(19) United States
(12) Patent Application Publication
(10) Pub. No.: US 2013/0052356 A1
(43) Pub. Date: Feb. 28, 2013

(54) Paper Coating Compositions For Grease and Water Resistance

(71) Applicant: Dawei Li, Tecumseh, MI (US)

(72) Inventor: Dawei Li, Tecumseh, MI (US)

(73) Assignee: WACKER CHEMICAL CORPORATION, Adrian, MI (US)

(21) Appl. No.: 13/222,299

(22) Filed: Aug. 31, 2011

(51) Int. Cl. B05D 3/10; C09D 147/00

(52) U.S. Cl. 427/387; 524/521

(57) ABSTRACT

Fluorochemical-free paper coatings which simultaneously exhibit good oil and grease resistance, hydrophobicity, and release properties are aqueous dispersions containing a water insoluble vinyl polymer, an addition-curable organopolysiloxane which cures through hydrosilylation, an Si—H functional crosslinker, and a catalyst for addition curing of the addition-curable organopolysiloxane. High oleophobicity, hydrophobicity, and release properties are developed even at low coating weights.

### BACKGROUND OF THE INVENTION

1. Field of the Invention

The invention relates to polymeric coating compositions for use on paper products to confer oil, grease, and water resistance. The coating compositions are prepared from an aqueous dispersion of addition polymers and a curable silicone emulsion, preferably an aqueous silicone emulsion crosslinkable through hydrosilylation.

2. Background Art

It is long known to treat paper and other porous products to render them resistant to the uptake of oils and greases, or water. Such coatings are said to provide oleophobicity or hydrophobicity. However, formulation of suitable coatings compositions is still difficult, particularly when both oil and grease resistance and also water resistance is desired. Many substances which are excellent candidates to provide hydrophobicity, for example, are not effective at providing oil or grease resistance, and the opposite is true as well. Natural and olefin waxes, and polymers based, for example, on ethylene, styrene, vinyl acetate, and hydrolyzed polyvinyl acetate (polyvinyl alcohol) have been suggested for these uses. However, while such products do sometimes confer good oil and grease resistance, they are required to be applied in relatively large amounts, reducing the flexibility of the coated paper substrate, and increasing cost as well. Moreover, these products only marginally aid water resistance unless applied in thick coats, and polyvinyl alcohol confers virtually no water resistance, since it is water soluble and hydrophilic. Such coatings also do not have significant release properties, which are also frequently required.

Thus, fluoro compounds have been widely used to simultaneously confer oil and grease resistance and water resistance, while also having some release properties. An advantage of such compounds is that they may be applied at relatively low areal weights and still function effectively. This ability to be sparingly used also reduces the cost disadvantage of these compounds, which are generally quite expensive. However, fluoro compounds are currently perceived to give rise to health and environmental concerns. Thus, there has been a desire to avoid the use of fluorochemicals, while still economically providing both oleophobic and hydrophobic properties and release properties, and being able to be applied in low areal weight.

### SUMMARY OF THE INVENTION

It has been surprisingly and unexpectedly discovered that oleophobic, hydrophobic, and release properties can be simultaneously achieved through use of a coating obtained from a curable aqueous dispersion, containing a water insoluble addition polymer and an aqueous emulsion of a curable silicone, preferably an addition curable silicone which cures through hydrosilylation, and curing the coating thusly applied.

### DETAILED DESCRIPTION OF THE PREFERRED EMBODIMENTS

The coatings of the invention preferably include a water insoluble addition polymer and an addition curable organopolysiloxane which cures through hydrosilylation, both in dispersed form. The composition also contains a crosslinker for the addition curable organopolysiloxane and a curing catalyst.

The addition curable organopolysiloxane is an organopolysiloxane curable by hydrosilylation, bearing carbon-carbon multiple bonds, preferably as ethylenic unsaturation. Examples of suitable unsaturated groups are vinyl, allyl, methallyl, propenyl, isopropenyl, ω-hexenyl, cyclohexenyl, norbornenyl, propargyl, acrylate, methacrylate, and the like. All unsaturated groups which are useful in addition curing organosilicon compositions may be used. The unsaturated groups are preferably linear aliphatic groups, and thus vinyl, allyl, and ω-hexenyl groups and the like are preferred. Vinyl is most preferred.

The unsaturated groups may be located in terminal groups such as a vinyldimethylsiloxy group, or may be chain pendant, for example in a vinylmethysiloxy group. Both terminal and pendant unsaturated groups may be present.

The organosilicon compound containing the unsaturated group may be linear, branched, or resinous. Linear organopolysiloxanes are based predominantly on repeating R₂SiO_{2/2} diorganosiloxy (“D”) groups, with substantially no trivalent RSiO_{3/2} monoorganosiloxy (“T”) groups or tetravalent SiO_{4/2} siloxy (silicate) (“Q”) groups. In these groups, the R group may be one of the unsaturated moieties previously mentioned, or may be a hydrocarbon group R¹ which is free of carbon-carbon multiple bonds. Mixtures of linear, branched, and/or resinous addition-curable organosilicon compounds may be used.

Examples of R¹ include alkyl radicals such as the methyl, ethyl, n-propyl, isopropyl, n-butyl, isobutyl, tert-butyl, n-pentyl, isopentyl, neopentyl, and tert-pentyl radicals, hexyl radicals such as the n-hexyl radical, heptyl radicals such as the n-heptyl radical, octyl radicals such as the n-octyl radical and isooctyl radicals such as the 2,2,4-trimethylpentyl radical, nonyl radicals such as the n-nonyl radical, decyl radicals such as the n-decyl radical, dodecyl radicals such as the n-dodecyl radical, and octadecyl radicals such as the n-octadecyl radical, cycloalkyl radicals such as the cyclopentyl, cyclohexyl, cycloheptyl and methylcyclohexyl radicals, aryl radicals such as the phenyl, naphthyl, anthryl and phenanthryl radicals, alkaryl radicals such as the o-, m-, and p-tolyl radicals, xylyl radicals and ethylphenyl radicals, and aralkyl radicals such as the benzyl radical, and the α- and the β-phenylethyl radicals.

Preferred are methyl, phenyl, and long chain alkyl groups, i.e. aliphatic R¹ which contain at least four carbon atoms, preferably 6-20 carbon atoms, and most preferably 8 to 18 carbon atoms. Methyl groups are most preferred as R¹.

Also useful are branched organopolysiloxanes. These may be prepared by incorporation of T and Q units previously described, or may be prepared by linking or grafting an organopolysiloxane chain onto a multivalent “starter” molecule, the valency being above 3, preferably 3 to 10, and more preferably 3-6. Examples of such branched organopolysiloxanes may be found in U.S. Pat. Nos. 6,764,717; 6,956,096; 7,135,513; 7,153,912; and 7,238,755, which are incorporated herein by reference.

Organopolysiloxane resins, particularly those which are liquid at the application temperature, are also useful. As is well known, these highly branched resins contain a high proportion of T and Q units. Examples include silsesquioxane resins, and the so-called MT resins, MQ resins, MQT resins, etc., where “M” is a monofunctional (terminal) unit R₃SiO_{1/2}. Resins which are so highly crosslinked or of such a high molecular weight such that they remain solid at the application temperature are not preferred for use alone, although they may be used in conjunction with other liquid organopolysiloxanes.

The addition curable organopolysiloxanes are commercially available products or may be prepared by conventional techniques of organosilicon chemistry. Examples of suitable synthetic methods may be found in Walter Noll, Chemistry and Technology of Silicones, Academic Press, ©1968, and in the patent references previously cited. Most preferred are liquid, substantially linear or branched organopolysiloxanes bearing vinyl and methyl groups, or vinyl, methyl, and long chain alkyl groups. The unsaturated groups are preferably terminal groups, and thus linear polydimethylsiloxanes terminated with vinyldimethylsiloxy groups, or lightly branched polydimethysiloxanes terminated with vinyldimethylsiloxy groups are most preferred. Somewhat less desirable but still preferred are linear or lightly branched organopolysiloxanes containing lateral (pendant) unsaturation, preferably vinyl, in lieu of or in addition to terminal groups.

The degree of polymerization of the addition curable organopolysiloxanes is not critical, and low viscosity fluids as well as high viscosity fluids are suitable. Viscosities of 20 to 1,000,000 mPa·s are preferred, more preferably 50 to 100,000 mPa·s and most preferably 100 to 50,000 mPa·s.

The crosslinking agent is an Si—H-functional organopolysiloxane, which may be similar to the structures of the addition curable organopolysiloxanes, except for having silicon bonded hydrogen in lieu of silicon-bonded unsaturated groups. The crosslinkers in general contain at least three Si—H groups on average, although crosslinkers containing only two Si—H groups are acceptable when the addition curable organopolysiloxane has a functionality greater than three.

Preferred crosslinkers are relatively low molecular weight linear or branched organopolysiloxanes preferably containing hydrogenmethylsiloxy and dimethylsiloxy groups, with trimethylsiloxy or hydrogendimethylsiloxy terminal groups. Examples of suitable crosslinkers are described in the aforementioned U.S. patents, for example U.S. Pat. Nos. 6,764,717 and 7,238,755. A preferred crosslinker is crosslinker V72, available from Wacker Chemical Corporation, Adrian, Mich., and Wacker Chemie AG, Munich, Germany.

The curing catalyst may be any addition curable catalyst which promotes cure through hydrosilylation. Many such catalysts are known from the literature, and many are disclosed in the aforementioned U.S. patents. Reference may also be made to Noll, op. cit., and to U.S. Pat. Nos. 3,775,452 and 3,715,334, and to Marciniec, Ed. COMPREHENSIVE HANDBOOK OF HYDROSILYLATION, Pergamon Press, New York, all of which are incorporated herein by reference.

The composition may also include an inhibitor which inhibits curing by hydrosilylation. Many suitable inhibitors are known and commercially available, and include sulfur and phosphorus compounds and ethylynically unsaturated compounds. Ethylynically unsaturated compounds such as cyclohexylethynol and “dehydrolinalool”, 3,7-dimethyl-6-octen-1-yn-3-o1, available from BASF S.E. are suitable, for example. The inhibitors inhibit room temperature curing, but still provide for rapid curing rates at higher temperatures, thus providing a longer pot life.

The addition curable organopolysiloxane is generally supplied as a plural component system, preferably a two or three component system. More rarely, a one component system may be formulated, but this is not preferred. When formulated as a two or three component system, one component generally contains the organopolysiloxane bearing hydrosilylatable unsaturated groups, often also including the hydrosilylation catalyst and optional inhibitor, and the second component generally contains the Si—H-functional crosslinker. When a third component is used, this component generally includes the hydrosilylation catalyst, often dissolved or dispersed in non-functional organopolysiloxanes or in one but not both of the functional organopolysiloxanes. In the case of the use of plural component systems, it is the practice that not all of the ingredients required for hydrosilylative crosslinking be contained in the same component, i.e. unsaturated-functional organopolysiloxanes, Si—H-functional organopolysiloxane, and hydrosilylation catalyst.

There are variants of hydrosilylation-curable organopolysiloxanes which are also useful in principle. For example, both Si—H functionality and hydrosilylatable unsaturation may be contained in the same organopolysiloxane. In addition, aqueous dispersions containing an unsaturated organopolysiloxane as one dispersed phase and the Si—H-functional organopolysiloxane as a distinct dispersed phase may be used. However, these are not preferred.

The mol ratio of Si—H groups and hydrosilylatable unsaturation may span a wide range, for example 1:10 to 10:1. However, the use of Si—H groups in molar excess is preferred. Addition curable dispersions are commercially available and include suggested ratios of the crosslinking groups. Any ratio of these groups and any amount of catalyst which provides for acceptable cure under the curing conditions is suitable. Cure may sometimes be effected at room temperature or below, but elevated temperature cure is conventional, particularly when inhibitors are also present. Cure may be accomplished, without limitation, for example, at 40-150° C., more preferably 50-100° C., and most preferably 60-90° C. Cure may take place in conventional curing ovens, for example.

In addition to the addition curable organopolysiloxanes curable through hydrosilylation, use may also be made of other curable organopolysiloxanes of the addition curable and condensation curable types. For example, in the above hydrosilylation curable silicones, the Si—H functional crosslinker and hydrosilylation catalyst may be dispensed with, and an addition catalyst included instead. Suitable addition catalysts include the well known peroxide and azo free radical addition catalysts, which are used in conventional quantities. Also suitable are photo-activated catalysts which produce free radicals upon irradiation, such as the well known DAROCURE catalysts available from BASF. In addition, emulsions of condensation curable silicones, such as those disclosed in U.S. Pat. No. 6,054,523, which is incorporated by reference herein, may be used. Use of these types of silicones is not preferred, however.

The addition polymers which are useful are water insoluble polymers in finely dispersed form. The addition polymers do not contain large amounts of hydrophilic moieties such as vinyl alcohol, vinyl amine, carboxylic acid groups, carboxylate salt groups, sulfonate, phosphonate, polyglycol, or polysaccharide groups such that the polymer becomes appreciably soluble in water. Preferably the addition polymer is substantially hydrophobic, and virtually insoluble in water.

The addition polymers are prepared by aqueous emulsion polymerization of one or more ethylenically unsaturated monomers Suitable water-insoluble, film-forming polymers comprise one or more monomer units selected from the group consisting of vinyl esters of unbranched or branched alkylcarboxylic acids having from 1 to 15 carbon atoms, methacrylic and acrylic esters of unbranched or branched alcohols having from 1 to 12 carbon atoms, fumaric and maleic monoesters or diesters of unbranched or branched alcohols having from 1 to 12 carbon atoms, dienes such as butadiene or isoprene, olefins such as ethene or propene, vinylaromatics such as styrene, methylstyrene or vinyltoluene, and vinyl halides such as vinyl chloride. For the purposes of the present invention, water-insoluble means that the solubility of the polymers under normal conditions is less than 1 g per liter of water. For film formation, the polymer composition is generally selected such that film formation occurs at the processing temperature, preferably such that a glass transition temperature Tg of from −30° C. to +80° C. results.

Preferred vinyl esters are vinyl acetate, vinyl propionate, vinyl butyrate, vinyl 2-ethylhexanoate, vinyl laurate, 1-methylvinyl acetate, vinylpivalate and vinyl esters of alpha-branched monocarboxylic acids having from 5 to 11 carbon atoms, for example VeoVa9^{R} or VeoVa10 (trade names of Shell). Particular preference is given to vinyl acetate.

Preferred methacrylic or acrylic esters are methyl acrylate, methyl methacrylate, ethyl acrylate, ethyl methacrylate, propyl acrylate, propyl methacrylate, n-butyl acrylate, t-butyl acrylate, n-butyl methacrylate, t-butyl methacrylate, 2-ethylhexyl acrylate. Particular preference is given to methyl acrylate, methyl methacrylate, n-butyl acrylate and 2-ethylhexyl acrylate.

Preferred ester groups of fumaric and maleic acid esters are methyl, ethyl, n-propyl, iso-propyl, n-butyl, iso-butyl, t-butyl, hexyl, ethylhexyl and dodecyl groups.

The copolymers may also comprise 0.05 to 10.0% by weight, based on the total weight of the comonomer mixture, of auxiliary monomers, of polyethylenically unsaturated comonomers, for example divinyl adipate, diallyl maleate, allyl methacrylate or triallyl cyanurate. Suitable auxiliary monomers are also comonomers having a crosslinking action, for example acrylamidoglycolic acid (AGA), methacrylamidoglycolic acid methyl ester (MAGME), N-methylolacrylamide (NMAA), N-methylolmethacrylamide, allyl N-methylolcarbamate and alkyl ethers, such as the isobutoxy ether, or esters of N-methylolacrylamide, of N-methylolmethacrylamide or allyl N-methylolcarbamate. The use of auxiliary monomers is not preferred.

The water-insoluble polymers can be polymerized by free radicals and are preferably prepared by the emulsion polymerization process. The polymerization can be carried out discontinuously or continuously, with or without the use of seed latices, with initial introduction of all the constituents or individual constituents of the reaction mixture, or with initial introduction of a portion and subsequent metering of the constituents or individual constituents of the reaction mixture, or by the metering method without an initial mixture. All the meterings are preferably carried out at the rate of consumption of the particular component. The polymerization is preferably carried out in a temperature range from 0 to 100° C., and is initiated using the methods usually employed for emulsion polymerization. The initiation is carried out by means of the customary, water-soluble agents which form free radicals, which are preferably employed in amounts of 0.01 to 3.0% by weight, based on the total weight of the monomers. All the emulsifiers and/or protective colloids usually used in emulsion polymerization can be employed as dispersing agents.

If appropriate, up to 6% by weight, based on the total weight of the monomers, of emulsifier is employed. Possible emulsifiers here are both anionic and cationic as well as nonionic emulsifiers. Protective colloids are preferably employed, particularly preferably in amounts of up to 15% by weight, based on the total weight of the monomers. Examples of these are polyvinyl alcohols and derivatives thereof, such as vinyl alcohol/vinyl acetate copolymers, polyvinylpyrrolidones; polysaccharides in water-soluble form, such as starches (amylose and amylopectin), cellulose, guar, tragacanthic acid, dextran, alginates and carboxymethyl, methyl, hydroxyethyl and hydroxypropyl derivatives thereof; proteins, such as casein, soya protein and gelatin; synthetic polymers, such as poly(meth)acrylic acid, poly(meth)acrylamide, polyvinylsulfonic acids and water-soluble copolymers thereof; melamine-formaldehydesulfonates, naphthalene-formaldehydesulfonates, and styrene/maleic acid and vinyl ether/maleic acid copolymers. In the most preferred embodiment, the polymerization is carried out with a protective colloid and without addition of an emulsifier. The protective colloid and/or emulsifier is not taken into account when measuring the water solubility of the addition polymer.

Preferred polymers include homopolymers of vinyl acetate and copolymers of vinyl acetate with ethylene, with vinyl versatate, with ethylene and vinyl versatate, and each of the foregoing polymers with n-butylacrylate. Also preferred are copolymers of styrene and n-butylacrylate.

Especially preferred are homopolymers of vinyl acetate, and copolymers of vinyl acetate and ethylene; of vinyl acetate, ethylene, and vinyl versatate, preferably VeoVa 9, VeoVa 10, or VeoVa11; of vinyl acetate, ethylene, and vinyl laurate; of vinyl acetate and vinyl versatate; of vinyl acetate and vinyl laurate; polymers containing n-butylacrylate, styrene/n-butylacrylate copolymers, styrene butadiene polymers, polyvinyl chloride polymers and copolymers, and the like. Most preferred are polyvinyl acetate homopolymers, and copolymers of vinyl acetate with ethylene, vinyl acetate with a vinyl ester of a C₄-C₂₀ alcohol, or vinyl acetate with ethylene and a vinyl ester of a C₄₋₂₀ alcohol. Also suitable are partial hydrolysates of vinyl acetate homopolymers and copolymers where the degree of hydrolysis is such that the hydrolyzed polymers remain substantially insoluble in water. Suitable initiators include peroxides and hydroperoxides, azo compounds, redox systems, and the like. Following completion of post polymerization, stripping of unreacted monomers, post polymerization, etc., all completely conventional techniques, may be utilized. Such addition polymer dispersions are commercially available. In addition to the dispersions per se, redispersible polymer powders which produce such dispersions upon redispersing in water may be used. A preferred addition polymer dispersions is VINNAPAS® 315 polymer dispersion available from Wacker Chemicals, a polyvinyl alcohol stabilized ethylene/vinyl acetate copolymer at 55 weight percent solids.

The resulting emulsion generally has a solids content of from 30-60% by weight, although higher and lower solids contents are also useful, and may be used as is, may be concentrated by solvent removal, or may be diluted with water or with a water soluble solvent, preferably one which does not cause significant swelling or solubilization of the polymer, such as methanol, ethanol, or isopropanol. Low VOC equivalent solvents such as t-butylacetate may be used in minor quantities. Preferably, no organic solvent other than a low molecular weight alcohol is used. Most preferably, no organic solvent is used, or if used, is used in amounts of less than 10% by weight relative to the total weight of the coating composition, more preferably less than 5% by weight, yet more preferably less than 2% by weight, and most preferably less than 1% by weight.

In use, the aqueous addition polymer dispersion is preferably admixed with an aqueous emulsion of the addition curable silicone composition. The latter generally includes a hydrosilylation catalyst, and generally also an inhibitor. Just prior to use, an emulsion of the crosslinker is blended in, and the composition is applied to the substrate by spraying, brushing, dipping, roll coating, doctor blade coating, or any other suitable coating process, in an amount necessary to provide a coating which is effective to provide suitable grease and oil and water resistance and most preferably, release properties as well. The wet add-on is difficult to quantify, since it will depend on variables such as the solids content of the coating composition and the porosity of the substrate, as well as the degree of performance desired. In general, coating thicknesses of 0.05 mil to 2 mil (1.3 to 51 μm), more preferably 0.1 mil to 1 mil (2.5 to 25 μm) are preferred.

The addition polymer and the crosslinkable organopolysiloxane composition are preferably present in a weight ratio such that the addition crosslinkable organopolysiloxane is present in amounts of 20-80 weight percent, more preferably 30-70 weight percent, and most preferably 40-60 weight percent. The weight percentages are based on total solids of the crosslinkable silicone, in particular on total solids of addition polymer and the Si—H and hydrosilylatable organopolysiloxane components. The relative proportions can be used to adjust the Tg of the overall system, the viscoelasticity, and release level. The total solids can be varied to adjust viscosity and coating weight.

The substrate to which the compositions are applied are fibrous and preferably cellulosic, most preferably paper substrates such as Kraft paper, cardboard, corrugated cardboard, and the like. The paper may be glazed or unglazed, calendared or uncalendared. Lignocellulosic substrates are also suitable, for example chip board, low, medium, and high density fiberboard, and the like.

The hydrophobicization imparted by the inventive coating compositions may be assessed by conventional absorbtion tests, where the coated substrate is exposed to water for a given period of time, and the amount of water absorbed during this time is measured. A suitable and preferred is TAPPI T 441 om-04, based on studies by Cobb and others, and reported as a “Cobb value”, which is the mass of absorbed water in grams for one square meter of surface area (g/m²). An absorbtion of less than 20 g/m², more preferably less than 15 g/m², yet more preferably less than 10 g/m², and most preferably less than 5 g/m² is preferred.

The oil and grease resistance is also measured by customary tests. One such test is the TAPPI T 559 pm-96 “Grease resistance test for paper and paperboard”. In this test, resistance to oils and greases is assessed by placing a drop of a test solution on the coated paper and then wiping away after 15 seconds. If the paper is darkened by wetting, the test is regarded as a failure, and is repeated using a less aggressive solution until a “pass” is found. A total of 12 solutions, made from combinations of castor oil, n-heptane, and toluene are used as a “kit” of test solutions, with a result of 12 being the most oil and grease resistant and a result of 1 being the least resistant. The results are generally reported in terms of the “kit number”. A number of 3 or greater, measured at a coating thickness of 0.2 mil (5 μm), more preferably 4 or greater, and most preferably 5 or greater is preferred.

In the Examples below, unless indicated to the contrary, porous test paper of bleached Kraft-process paper with a basis weight of 81.5 g/m² is used. Coating rods and dispersions solids content were adjusted to achieve the targeted coating weights conventionally.

### Comparative Examples C1-C6

Test papers were rod coated using different Mayer rods to achieve coating thicknesses of 0.19, 0.23, 0.33, 0.38, 0.48, and 0.73 mils (4.8, 5.8, 8.4, 9.7, 12.2, and 18.5 μm, respectively). The coating composition consisted of a vinyldimethylsilyl-terminated polydimethylsiloxane as a 50 weight percent silicone solids aqueous emulsion also containing platinum-based hydrosilylation catalyst and polymerization inhibitor, available from Wacker Chemical Corporation as DEHESIVE® 400 release coating, which was admixed with a 38 weight percent silicone solids Si—H functional crosslinker V72 available from Wacker Chemical Corporation at an SiH:SiVi mol ratio of 4.5:1. The coated sheets were oven cured at 160° C. for 30 seconds. The coated sheets were evaluated for oil and grease resistance, and for water resistance. The results are presented below in the Table. Coated sheets were also evaluated for release properties by laminating with Tesa 7475 tape. The laminates were placed between glass plates at a pressure of 0.3 psi (2.1 kPa) and heat aged at 70° C. for 20 hours. The laminates were conditioned at room temperature for two hours prior to testing, and tested for release properties with a TMI instrument from Testing Machines, Inc. at 300 in/min (7.62 m/min) with 180° peel, in accordance with standard test methods. The results are also presented in the Table.

### Comparative Examples C7-C12

Similar to Comparative Examples 1-5, paper sheets were coated with a polyvinyl alcohol stabilized vinyl acetate-ethylene copolymer dispersion with a glass transition temperature of 17° C., with a solids content of ca. 55 weight percent and viscosity of 1800-2700 mPa·s, available from Wacker Chemie AG as VINNAPAS® 315 copolymer dispersion. The dried sheets were tested for oil and grease resistance, water resistance, and release properties as was done for Comparative Examples 1-5. The results are presented in the Table.

### Examples 13-18

Similar to Comparative Examples 1-5, paper sheets were coated with a dispersion of vinyl acetate-ethylene copolymer and crosslinkable vinyl-terminated polydimethylsiloxane polymer. The coating composition was prepared by homogenously blending 46 parts of VINNAPAS® 315 copolymer emulsion and 40 parts of DEHESIVE® 400 in a plastic beaker, following which the crosslinker emulsion V72 6 parts (all by weight) was added and homogeneously blended. The coatings were cured as before at 160° C. for 30 seconds and tested for oil and grease resistance, water resistance, and release properties. The results are presented in the Table.

In the tabulated results, the kit test values reflect oil/grease resistance. The higher the value, the higher the resistance. Values range from 1 (low) to 12 (high). For water resistance, the water absorbtion is given in g/m². The higher the value, the more water is absorbed, and the lower is the water resistance. For the release testing, the force necessary to maintain a release rate of 300 in/min (7.62 m/min) is measured. The higher the value, the lower is the releasability. Adhesion which was so high so as not to be releasable is designated as “lockup”. Comparative Examples are prefaced by a “C”.

TABLE

| | | Absorbed | | |
|---|---|---|---|---|
| | Coating Thickness, | Water, | Kit Test | Release Force, |
| Example | mil/μm | g/m² | Number | g/in |
| C1 | 0.19/4.8 | 30.64 | 2 | lockup |
| C2 | 0.23/5.8 | 39.59 | 2 | 351 ± 18 |
| C3 | 0.33/8.4 | 69.21 | 2 | 188 ± 39 |
| C4 | 0.38/9.7 | 38.24 | 2 | 276 ± 26 |
| C5 | 0.48/12.2 | 76.39 | 2 | 89 ± 17 |
| C6 | 0.73/18.5 | 68.29 | 2 | 47 ± 11 |
| C7 | 0.19/4.8 | 24.05 | 1 | lockup |
| C8 | 0.23/5.8 | 21.99 | 1 | lockup |
| C9 | 0.33/8.4 | 20.99 | 2 | lockup |
| C10 | 0.38/9.7 | 20.93 | 2 | lockup |
| C11 | 0.48/12.2 | 16.18 | 10 | lockup |
| C12 | 0.73/18.5 | 16.34 | 11 | lockup |
| 13 | 0.19/4.8 | 15.14 | 5 | 275 ± 17 |
| 14 | 0.23/5.8 | 10.24 | 5 | 213 ± 48 |
| 15 | 0.33/8.4 | 3.52 | 5 | 128 ± 41 |
| 16 | 0.38/9.7 | 7.98 | 5 | 151 ± 45 |
| 17 | 0.48/12.2 | 5.09 | 12 | 133 ± 33 |
| 18 | 0.73/18.5 | 1.97 | 12 | 100 ± 29 |

The testing results indicate that use of the addition curable silicone alone resulted in little increase in hydrophobicity. In fact, the lowest coating weights resulted in the highest water resistance, despite silicones ordinarily being considered quite hydrophobic. The polymer emulsion showed better water resistance, which increased somewhat as the coating thickness increased. Still, the thickest coating, more than three times as thick as the thinnest coating, improved only about 33% in water resistance. The inventive coatings exhibited water resistance, even at the lowest coating level (Example 13) which was higher than the polymer coating at its best (Comparative Example C12).

In terms of oil and grease resistance, the silicone coating was poor at all thicknesses, with kit values of only 2. The vinyl polymer was worse at low coating thicknesses, and became quite effective only at the two highest coating thicknesses. The inventive coatings were far superior to either the silicone or the vinyl polymer at coating thicknesses between 0.19 mils and 0.38 mils (4.8 and 9.7 μm), and were measurably superior at the highest coating thicknesses (0.48-0.73 mils; 12.2 to 18.5 μm). The coating thicknesses, and therefore also the coating weights, were comparable as between the respective groups of examples, e.g. the surprising and unexpected benefits of the subject invention coatings is not due to an increased coating weight.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A paper coating composition comprising
an aqueous dispersion of
a) a water insoluble vinyl addition polymer in an amount of 20-80 weight percent;
b) an addition-curable organopolysiloxane composition which cures by hydrosilylation, in an amount of 80-20 weight percent, the addition-curable organopolysiloxane composition containing an Si—H functional crosslinker; and
c) a hydrosilylation catalyst,
said coating composition, when cured, exhibiting oleophobicity, hydrophobicity, and release properties, wherein said weight percents are based on total solids of a) and b).

2. The composition of claim 1, wherein the oleophilicity expressed as a kit number measured in accordance with TAPPI T559 pm-96, is greater than 3 at coating thickness greater than 0.2 μm.

3. The composition of claim 1, wherein the vinyl addition polymer is a polymer or copolymer comprising vinyl acetate.

4. The composition of claim 1, wherein the vinyl addition polymer comprises a copolymer of vinyl acetate and ethylene.

5. The composition of claim 1, wherein the addition-curable organopolysiloxane comprises a polydiorganosiloxane having terminal and/or pendant hydrocarbon groups containing at least two carbon-carbon multiple bonds.

6. The composition of claim 1, wherein the addition-curable organopolysiloxane comprises a linear, branched, or resinous organopolysiloxane bearing vinyl unsaturation.

7. The composition of claim 1, wherein the addition-curable organopolysiloxane comprises an α,ω-divinyl-terminated polydimethylsiloxane.

8. The composition of claim 1, wherein a) is present in an amount of 30-70 weight percent and b) is present in an amount of 70-30 weight percent.

9. The composition of claim 1, wherein a) is present in an amount of 40-60 weight percent and b) is present in an amount of 60-40 weight percent.

10. A method of coating fibrous substrates to simultaneously provide oleophobicity, hydrophobicity, and release properties, comprising applying to the fibrous substrate the coating composition of claim 1 and curing the coating composition.

11. A method of coating fibrous substrates to simultaneously provide oleophobicity, hydrophobicity, and release properties, comprising applying to the fibrous substrate the coating composition of claim 2 and curing the coating composition.

12. A method of coating fibrous substrates to simultaneously provide oleophobicity, hydrophobicity, and release properties, comprising applying to the fibrous substrate the coating composition of claim 3 and curing the coating composition.

13. A method of coating fibrous substrates to simultaneously provide oleophobicity, hydrophobicity, and release properties, comprising applying to the fibrous substrate the coating composition of claim 4 and curing the coating composition.

14. A method of coating fibrous substrates to simultaneously provide oleophobicity, hydrophobicity, and release properties, comprising applying to the fibrous substrate the coating composition of claim 5 and curing the coating composition.

15. A method of coating fibrous substrates to simultaneously provide oleophobicity, hydrophobicity, and release properties, comprising applying to the fibrous substrate the coating composition of claim 6 and curing the coating composition.

16. A method of coating fibrous substrates to simultaneously provide oleophobicity, hydrophobicity, and release properties, comprising applying to the fibrous substrate the coating composition of claim 7 and curing the coating composition.

17. A method of coating fibrous substrates to simultaneously provide oleophobicity, hydrophobicity, and release properties, comprising applying to the fibrous substrate the coating composition of claim 8 and curing the coating composition.

18. A method of coating fibrous substrates to simultaneously provide oleophobicity, hydrophobicity, and release properties, comprising applying to the fibrous substrate the coating composition of claim 9 and curing the coating composition.

19. The method of claim 10, wherein the fibrous substrate is paper or cardboard.
